(19) United States
(12) Patent Application Publication
(10) Pub. No.: US 2011/0102344 A1
(43) Pub. Date: May 5, 2011

(54) PORTABLE ELECTRONIC DEVICE AND TABLET PERSONAL COMPUTER

(76) Inventors: Nai Heng Chang, Tai Chung City (TW); Cheng-Chieh Liu, Tai Chung County (TW); Chih-Chang Lai, Tai Chung County (TW)

(21) Appl. No.: 12/914,177

(22) Filed: Oct. 28, 2010

(30) Foreign Application Priority Data
Oct. 29, 2009 (TW) 098220010

(51) Int. Cl. G06F 3/041

(52) U.S. Cl. 345/173

(57) ABSTRACT

A portable electronic device including a main body and a wireless input unit is provided. The main body has a display surface and an accommodating portion opposite the display surface. The accommodating portion defines an accommodating space substantially parallel to the display surface. The wireless input unit is placed inside the accommodating space and capable of being extracted from the accommodating space. The wireless input unit is separate from the main body. The wireless input unit includes a touch panel, a pattern layer, and a control circuit. The touch panel has an operation surface and a back surface opposite the operation surface. The pattern layer is disposed on the back surface of the touch panel and has a plurality of control area patterns. The control circuit is disposed on the touch panel.

### BACKGROUND OF THE INVENTION

(a) Field of the Invention

The invention relates to a portable electronic device having a separate wireless input unit.

(b) Description of the Related Art

Nowadays, in an information explosion era, everyday life becomes inseparable from electronic products. Accompanying with the advance of electronic technology, new electronic products being user-friendly and having good functionality are unceasingly announced. For example, a tablet computer has great convenience in use and can be operated by a stylus on a table or one's lap. However, when some additional function is needed, a user should install the tablet computer on a docking station that is provided with a keyboard and an external mouse to operate the tablet computer through the keyboard and the mouse. Therefore, under certain circumstances, a tablet computer is inconvenient in use.

Further, in order to perform direct touch selections on the screen of a tablet computer, a portion of the screen area of the tablet computer should be reserved for displaying operation windows or control patterns. Thus, a user's viewing area may be blocked by the operation windows or control patterns to thereby affect the viewing comfortableness.

### BRIEF SUMMARY OF THE INVENTION

The invention provides a portable electronic device and a tablet computer having a separate wireless input unit. The wireless input unit has multiple functions and provides great convenience in use.

According to an embodiment of the invention, a portable electronic device includes a main body and a wireless input unit. The main body has a display surface and an accommodating portion opposite the display surface. The accommodating portion defines an accommodating space substantially parallel to the display surface. The wireless input unit is placed inside the accommodating space and capable of being extracted from the accommodating space, and the wireless input unit is separate from the main body. The wireless input unit includes a touch panel, a pattern layer, and a control circuit. The touch panel has an operation surface and a back surface opposite the operation surface. The pattern layer is disposed on the back surface of the touch panel and has a plurality of control area patterns. The control circuit is disposed on the touch panel.

According to another embodiment of the invention, a tablet computer includes a computer main body and a wireless input unit. The computer main body has a display surface and an accommodating portion opposite the display surface. The accommodating portion defines an accommodating space substantially parallel to the display surface. The wireless input unit is placed inside the accommodating space and capable of being extracted from the accommodating space, and the wireless input unit is separate from the computer main body. The wireless input unit includes a touch panel, a pattern layer, and a control circuit. The touch panel has an operation surface and a back surface opposite the operation surface. The pattern layer is disposed on the back surface of the touch panel and has a plurality of control area patterns. The control circuit is disposed on the touch panel.

In one embodiment, the touch panel is electrically connected to the main body of the portable electronic device or the computer main body through the control circuit.

In one embodiment, the touch panel is electrically connected to an external electronic apparatus through the control circuit. For example, the external electronic apparatus is a mobile phone, a display, or a player.

In one embodiment, each of the above control area patterns is a keyboard area pattern, a numeral area pattern, a mouse area pattern, a function-switching area pattern, or a playing area pattern.

In one embodiment, the control circuit is a wireless transmitting controller.

In one embodiment, the wireless input unit further includes a flexible circuit board connected to the touch panel and the control circuit. In one embodiment, the control circuit is disposed on the flexible circuit board and positioned on the back surface of the touch panel. On the other hand, the wireless input unit further includes a printing circuit board. The printing circuit board is disposed on the back surface of the touch panel, and the control circuit is disposed on the printing circuit board. The flexible circuit board is connected between the touch panel and the printing circuit board.

In one embodiment, the pattern layer is attached to the back surface of the touch panel.

In one embodiment, the pattern layer is coated on the back surface of the touch panel.

The embodiment or the embodiments of the invention may have at least one of the following advantages. First, since a separate wireless input unit is used as an input interface of a portable electronic device or a tablet computer, it is not necessary to place a display screen and an input unit together at an identical viewing direction, and thus it is more convenient to use them. Besides, the wireless input unit is directly accommodated on the back surface of the main body and the tablet computer to provide better portability, and the wireless input unit is allowed to control an external electronic apparatus outside the portable electronic device and the tablet computer. Further, the wireless input unit is controlled without a docking station and a connecting wire. Therefore, the number of components in a device is reduced to further increase convenience in use.

In order to further illustrate the above characteristics and advantages of the invention, the following uses embodiments accompanying with figures to describe the invention in details.

### BRIEF DESCRIPTION OF THE DRAWINGS

FIG. 1 shows a schematic diagram illustrating a portable electronic device according to one embodiment of the invention.

FIGS. 2A-2D show side views of different wireless input units according to various embodiments of the invention.

FIG. 3 shows a top-view of a pattern layer according to one embodiment of the invention.

### DETAILED DESCRIPTION OF THE INVENTION

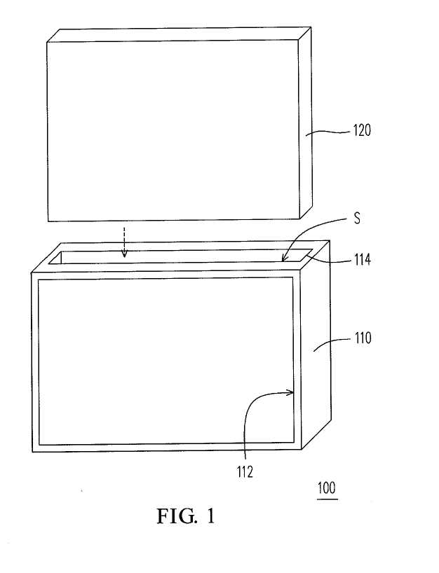

FIG. 1 shows a schematic diagram illustrating a portable electronic device according to one embodiment of the invention. Referring to FIG. 1, the portable electronic device 100 includes a main body 110 and a wireless input unit 120. The main body 110 has a display surface 112 and an accommodating portion 114 opposite the display surface 112. The accommodating portion 114 defines an accommodating space S substantially parallel to the display surface 112. The wireless input unit 120 is placed inside the accommodating space S and capable of being extracted from the accommodating space S, and the wireless input unit 120 is separate from the main body 110. Specifically, the portable electronic device 100 may be a tablet computer and the main body 110 may be a computer main body.

In the past, the design of a tablet computer integrates touch control elements into a display screen to, for example, perform direct touch selections or open windows on the screen. However, the window corresponding to current operations may occupy some portion of a viewing area of the display screen to thereby affect the viewing comfortableness. In addition, according to the conventional design, a tablet computer may be placed only on a table or user's lap. Thus, a user has to view the screen at a relatively slanted direction to thereby feel uncomfortable due to a large viewing angle.

In this embodiment, a separate wireless input unit 120 is used as an input element of the portable electronic device 100. Thus, when a user uses the portable electronic device 100, the main body 110 may be placed vertically on the table for viewing convenience. At the same time, the user may place the wireless input unit 120 on a position along with his preference to control the main body 110. For example, the wireless input unit 120 may be placed on user's lap or on a table. Therefore, the portable electronic device 100 is operated conveniently like a desktop computer. Besides, in this embodiment, the wireless input unit 120 may be directly accommodated in the main body 110 without any transmission wires connected to the main body 110. Thus, the portable electronic device 100 may possess portability like a tablet computer.

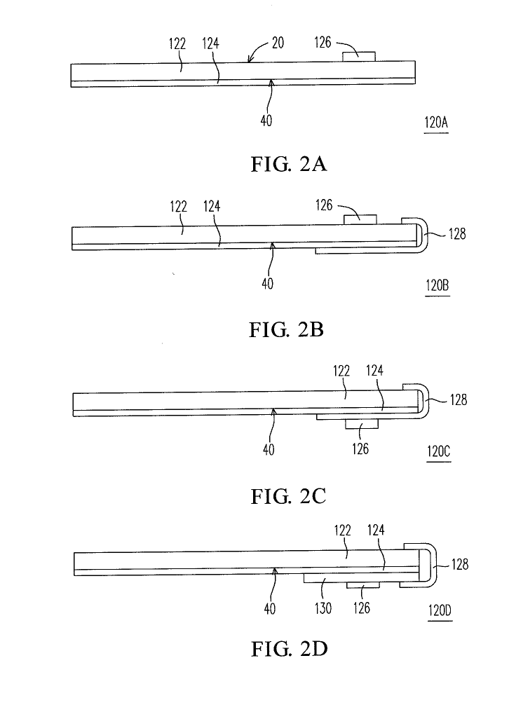

FIGS. 2A-2D show side views of different wireless input unit according to various embodiments of the invention. Referring to FIG. 2A, the wireless input unit 120A includes a touch panel 122, a pattern layer 124, and a control circuit 126. The touch panel 122 has an operation surface 20 and a back surface 40. The pattern layer 124 is disposed on the back surface 40 of the touch panel 122. The control circuit 126 is disposed on the touch panel 122.

Referring to both FIG. 1 and FIG. 2A, the control circuit 126, for example, includes a controller (not shown) and a wireless transmitter (not shown) to control and drive the touch panel 122 and to transmit commands from the touch panel 122 to the main body 110. That is, the touch panel 122 is electrically connected to the main body 110 or a computer main body (not shown) through the control circuit 126.

In addition, the control circuit 126 may be provided with a decoder (not shown). Therefore, the touch panel 122 may be electrically connected to an external electronic apparatus (not shown) through the control circuit 126. For example, the external electronic apparatus may be a mobile phone, a display, or a player. In other words, the wireless input unit 120A in this embodiment may be used to control not only the main body 110 but also other electronic apparatus. Thus, the wireless input unit 120A may serve as a universal remote controller to bring great convenience in use.

Referring to FIG. 2B, in another embodiment, the wireless input unit 120B further includes a flexible circuit board 128. The flexible circuit board 128 is connected to the touch panel 122 and the control circuit 126. Alternatively, in the wireless input unit 120C shown in FIG. 2C, the control circuit 126 is disposed on the flexible circuit board 128 and positioned on the back surface 40 of the touch panel 122. In the other embodiment as shown in FIG. 2D, the wireless input unit 120D further includes a printing circuit board 130. The printing circuit board 130 is disposed on the back surface 40 of the touch panel 122, the control circuit 126 is disposed on the printing circuit board 130, and the flexible circuit board 128 is connected between the touch panel 122 and the printing circuit board 130.

Besides, in the above wireless input units 120A-120D, the pattern layer 124 may be adhered to or coated on the touch panel 122. That is, the pattern layer 124 may be a coating layer formed by various pigments or a film like a sticker.

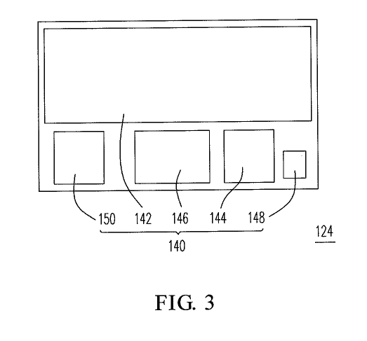

More specifically, FIG. 3 shows a top-view illustrating a pattern layer according to an embodiment of the invention. Referring to both FIGS. 1 and 3, in order to provide the wireless input unit 120 with various input functions, the pattern layer 124, for example, has a plurality of control area patterns 140. The control area patterns 140 may include a keyboard area pattern 142, a numeral area pattern 144, a mouse area pattern 146, a function-switching area pattern 148, a playing area pattern 150, etc.

For example, when the wireless input unit 120 is used to control the main body 110, a user, for example, may perform the operations of inputting, selecting, dragging, etc. on the keyboard area pattern 142, the numerical area pattern 144, and the mouse area pattern 146. When the wireless input area 120 is used to control a video player, a user may perform the operations of play, pause, fast forward, or fast backward, etc. by selecting corresponding blocks in the playing area pattern 150. Of course, the above patterns are illustrated as an example. The patterns in the pattern layer 124 are arbitrary designed according actual demands and functional requirements.

According to the above embodiments, the pattern layer 124 provides different input areas for respective functions, so the wireless input unit 120 can be operated by a user without being provided on a display screen. Therefore, it does not need to make sacrifices in the screen viewing area to show operation windows or control patterns.

The embodiment or the embodiments of the invention may have at least one of the following advantages. First, since a separate wireless input unit is used as an input interface of a portable electronic device or a tablet computer, it is not necessary to place a display screen and an input unit together at an identical viewing direction, and thus it is more convenient to use them. Besides, the wireless input unit is directly accommodated on the back surface of the main body and the tablet computer to provide better portability, and the wireless input unit is allowed to control an external electronic apparatus outside the portable electronic device and the tablet computer. Further, the wireless input unit is controlled without a docking station and a connecting wire. Therefore, the number of components in a device is reduced to further increase convenience in use.

Although the present invention has been fully described by the above embodiments, the embodiments should not constitute the limitation of the scope of the invention. Various modifications or changes can be made by those who are skilled in the art without deviating from the spirit of the invention.

What is claimed is:

1. A portable electronic device, comprising:
a main body having a display surface and an accommodating portion opposite the display surface, wherein the accommodating portion defines an accommodating space substantially parallel to the display surface; and
a wireless input unit placed inside the accommodating space and capable of being extracted from the accommodating space, wherein the wireless input unit is separate from the main body and comprises:
a touch panel having an operation surface and a back surface opposite the operation surface;
a pattern layer disposed on the back surface of the touch panel and having a plurality of control area patterns; and
a control circuit disposed on the touch panel.

2. The portable electronic device according to claim 1, wherein the touch panel is electrically connected to the main body through the control circuit.

3. The portable electronic device according to claim 1, wherein the touch panel is electrically connected to an external electronic apparatus through the control circuit.

4. The portable electronic device according to claim 3, wherein the external electronic apparatus is a mobile phone, a display, or a player.

5. The portable electronic device according to claim 1, wherein each of the control area patterns comprises a keyboard area pattern, a numeral area pattern, a mouse area pattern, a function-switching area pattern, or a playing area pattern.

6. The portable electronic device according to claim 1, wherein the control circuit is a wireless transmitting controller.

7. The portable electronic device according to claim 1, wherein the wireless input unit further comprises:
a flexible circuit board connected to the touch panel and the control circuit.

8. The portable electronic device according to claim 7, wherein the wireless input unit further comprises:
a printing circuit board disposed on the back surface of the touch panel, wherein the control circuit is disposed on the printing circuit board and the flexible circuit board is connected between the touch panel and the printing circuit board.

9. The portable electronic device according to claim 7, wherein the control circuit is disposed on the flexible circuit board and positioned on the back surface of the touch panel.

10. The portable electronic device according to claim 1, wherein the pattern layer is attached to the back surface of the touch panel or coated on the back surface of the touch panel.

11. A tablet computer, comprising:
a computer main body having a display surface and an accommodating portion opposite the display surface, wherein the accommodating portion defines an accommodating space substantially parallel to the display surface; and
a wireless input unit placed inside the accommodating space and capable of being extracted from the accommodating space, wherein the wireless input unit is separate from the computer main body and comprises:
a touch panel having an operation surface and a back surface opposite the operation surface;
a pattern layer disposed on the back surface of the touch panel and having a plurality of control area patterns; and
a control circuit, disposed on the touch panel.

12. The tablet computer according to claim 11, wherein the touch panel is electrically connected to the computer main body through the control circuit.

13. The tablet computer according to claim 11, wherein the touch panel is electrically connected to an external electronic apparatus through the control circuit.

14. The tablet computer according to claim 13, wherein the external electronic apparatus is a mobile phone, a display, or a player.

15. The tablet computer according to claim 11, wherein each of the control area patterns comprises a keyboard area pattern, a numeral area pattern, a mouse area pattern, a function-switching area pattern, or a playing area pattern.

16. The tablet computer according to claim 11, wherein the control circuit is a wireless transmitting controller.

17. The tablet computer according to claim 11, wherein the wireless input unit further comprises:
a flexible circuit board connected to the touch panel and the control circuit.

18. The tablet computer according to claim 17, wherein the wireless input unit further comprises:
a printing circuit board disposed on the back surface of the touch panel, wherein the control circuit is disposed on the printing circuit board and the flexible circuit board is connected between the touch panel and the printing circuit board.

19. The tablet computer according to claim 17, wherein the control circuit is disposed on the flexible circuit board and positioned on the back surface of the touch panel.

20. The tablet computer according to claim 11, wherein the pattern layer is attached to the back surface of the touch panel or coated on the back surface of the touch panel.
